(19) United States
(12) Patent Application Publication
(10) Pub. No.: US 2024/0287734 A1
(43) Pub. Date: Aug. 29, 2024

(54) HYDROPHOBIZING AND STRENGTHENING AGENT FOR CARPET FIBER BOARDS

(71) Applicant: Wacker Chemie AG, Munich (DE)

(72) Inventors: Daniel J Mania, Saline, MI (US); James Greene, Ypsilanti, MI (US)

(21) Appl. No.: 18/569,265

(22) PCT Filed: Jun. 29, 2021
(86) PCT No.: PCT/EP2021/067771

§ 371 Date: Dec. 12, 2023

(51) Int. Cl. D06M 13/513

(52) U.S. Cl. CPC D06M 13/513; D06M 2200/12

(57) ABSTRACT

An additive along with methods for producing the same. Where the additive is used to decrease an amount of water absorption and improve the overall flexural strength of carpet fiber boards.

### TECHNICAL FIELD

The invention relates to the use of an additive for decreasing the water absorption and improving the flexural strength of carpet fiber boards, wherein the additive comprises at least one organosilicon compound comprising structural units of formula (I)

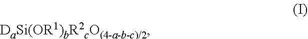

where

D may be identical or different and denotes a monovalent, SiC-bonded radical containing basic nitrogen,

R¹ may be identical or different and denotes a hydrogen atom or optionally substituted hydrocarbon radicals,

R² may be identical or different and denotes a monovalent, optionally substituted, SiC-bonded organic radical free from basic nitrogen,

a is 0, 1, 2, 3, or 4,

b is 0, 1, 2, or 3,

c is 0, 1, 2, or 3,

with the proviso that the sum of a+b+c is less than or equal to 4 and there is at least one radical D present per molecule.

### BACKGROUND ART

Carpet waste from new carpet production or used carpet applications causes a significant waste problem. Often, carpet waste is not recycled, but rather is disposed of by land-filling or burning, which is environmentally problematic and expensive. Accordingly, in the past methods have been developed wherein carpet waste was used to produce plastic composites that still function acceptably in a variety of applications, while being inexpensive to manufacture.

U.S. Pat. No. 9,637,920 B2 discloses a composite material produced from carpet waste and a binding agent, in intimate association, and may also include wood fiber or chips and/or other additives. It further discloses a method of manufacturing said composite material including shredding carpet waste, coating the carpet waste with a binding agent, and subjecting the shredded, coated carpet waste to elevated heat and pressure. As an additional step, the composite material may be actively cooled to prevent deformation of the material.

The boards made from such composite material are typically used in decking, cladding, siding, etc. However, such boards absorb over 30% by weight of water making them unsuitable for applications with exposure to water or humid conditions.

Accordingly, it has been an object to find a suitable additive which can be used for decreasing the water absorption and improving the flexural strength of carpet fiber boards. Preferably, such additive also imparts improved flexural strength.

This problem has actually been solved by the present invention, namely, by using an additive comprising at least one organosilicon compound comprising structural units of formula (I)

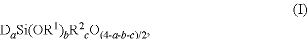

where

D may be identical or different and denotes a monovalent, SiC-bonded radical containing basic nitrogen,

R¹ may be identical or different and denotes a hydrogen atom or optionally substituted hydrocarbon radicals,

R² may be identical or different and denotes a monovalent, optionally substituted, SiC-bonded organic radical free from basic nitrogen,

a is 0, 1, 2, 3, or 4,

b is 0, 1, 2, or 3,

c is 0, 1, 2, or 3,

with the proviso that the sum of a+b+c is less than or equal to 4 and there is at least one radical D present per molecule.

In particular, carpet fiber boards that have been treated with said additive show a decrease in water absorption to less than 5% by weight and an improvement of the flexural strength up to twice the original value.

### DETAILED DESCRIPTION OF THE INVENTION

The present invention relates to the use of an additive for decreasing the water absorption and improving the flexural strength of carpet fiber boards, wherein the additive comprises:
(A) at least one organosilicon compound comprising structural units of formula (I)

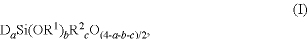

where

D may be identical or different and denotes a monovalent, SiC-bonded radical containing basic nitrogen, R¹ may be identical or different and denotes a hydrogen atom or optionally substituted hydrocarbon radicals,

R² may be identical or different and denotes a monovalent, optionally substituted, SiC-bonded organic radical free from basic nitrogen,

a is 0, 1, 2, 3, or 4,

b is 0, 1, 2, or 3,

c is 0, 1, 2, or 3,

with the proviso that the sum of a+b+c is less than or equal to 4 and there is at least one radical D present per molecule.

The organosilicon compound may be silane, a (poly)organosiloxane, or a silicone resin.

The radicals R¹ are preferably hydrogen atom and hydrocarbon radicals that are optionally substituted by halogen atoms and that have 1 to 18 carbon atoms; more preferably, hydrogen atom and hydrocarbon radicals that have 1 to 10 carbon atoms; more particularly, methyl radical and ethyl radical.

Radical R² preferably comprises hydrocarbon radicals that are optionally substituted by halogen atoms and that have 1 to 18 carbon atoms, more preferably hydrocarbon radicals having 1 to 5 carbon atoms, more particularly the methyl radical.

Examples of radicals D are radicals of the formulae H₂N (CH₂)₃—, H₂N (CH₂)₂NH(CH₂)₃—, H₂N (CH₂)₂NH (CH₂)₂NH(CH₂)₃—, H₃CNH (CH₂)₃—, C₂H₅NH (CH₂)₃—, C₃H₇NH(CH₂)₃—, C₄H₉NH(CH₂)₃—, C₅H₁₁NH(CH₂)₃—, C₆H₁₃NG(CH₂)₃—, C₇H₁₅NH(CH₂)₃—, H₂N(CH₂)₄—, H₂N—CH₂—CH(CH3—CH₂—H₂N (CH₂)₅—, cyclo-C₅H₉NH(CH₂)₃—, cyclo-C₆H₁₁NH(CH₂)₃—, phenyl-NH(CH₂)₃—, (CH₃)₂N(CH₂)₃—, (C₂H₅)₂N (CH₂)₃—, (C₃H₇)₂NH(CH₂)₃—, (C₄H₉)₂NH (CH₂)₃—, (C₅H₁₁)₂NH(CH₂)₃—, (C₆H₁₃)₂NH (CH₂)₃—, (C₇H₁₅)₂NH(CH₂)₃—, H₂N(CH₂)—, H₂N(CH₂)₂NH(CH₂)—, H₂N(CH₂)₂NH(CH₂)₂NH(CH₂)—, H₃CNH (CH₂)—, C₂H₅NH (CH₂)—, C₃H₇NH(CH₂)—, C₄H₉NH(CH₂)—, C₅H₁₁NH(CH₂)—, C₆H₁₃NH(CH₂)—, CH₁₅NH(CH₂)—, cyclo-C₅H₉NH(CH₂)—, cyclo-C₆H₁₁NH(CH₂)—, phenyl-NH(CH₂)—, (CH₃)₂N(CH₂)—, (C₂H₅)₂N(CH₂)—, (C₃H₇)₂NH(CH₂)—, (C₄H₉)₂NH (CH₂)—, (C₅H₁)₂NH(CH₂)—, (C₆H₁₃)₂NH(CH₂)—, (C₇H₁₅)₂NH(CH₂)—, (CH₃₀)₃Si(CH₂)₃NH(CH₂)₃—, (C₂H₅O)₃Si(CH₂)₃NH(CH₂)₃—, (CH₃O)₂(CH₃)Si(CH₂)₃NH(CH₂)₃—, and (C₂H₅O)₂(CH₃)Si(CH₂)₃NH(CH₂)₃—, and also reaction products of the abovementioned primary amino groups with compounds containing epoxide groups or double bonds that are reactive toward primary amino groups.

Preferably, radical D may be identical or different and denotes a monovalent, SiC-bonded radical having at least one primary and/or secondary amino group.

Radical D preferably comprises the H₂N (CH₂)₃—,

H₂N(CH₂)₂NH(CH₂)₃—, and cyclo-C₆H₁₁NH(CH₂)₃— radical.

Preferably, the organosilicon compound is

(A1) a silane, wherein a+b+c is equal to 4, or

(A2) a (poly) organosiloxane, wherein a+b+c is less than or equal to 3,

or a combination of (A1) and (A2).

More preferably, the organosilicon compound is (A1) a silane, wherein a+b+c is equal to 4.

Examples of the silanes of the formula (I), wherein a+b+c is equal to 4, are H₂N(CH₂)₃—Si(OCH₃)₃, H₂N(CH₂)₃—Si(OC₂H₅)₃, H₂N(CH₂)₃—Si(OCH₃)₂CH₃, H₂N(CH₂)₃—Si(OC₂H₅)₂CH₃, H₂N(CH₂)₂NH(CH₂)₃—Si(OCH₃)₃, H₂N(CH₂)₂NH(CH₂)₃—Si(OC₂H₅)₃, H₂N(CH₂)₂NH (CH₂)₃—Si(OCH₃)₂CH₃, H₂N(CH₂)₂NH(CH₂)₃—Si(OC₂H₅)₂CH₃, H₂N(CH₂)₂NH(CH₂)₃—Si(OH)₃, H₂N (CH₂)₂NH(CH₂)₃—Si(OH)₂CH₃, H₂N(CH₂)₂NH(CH₂)₂NH(CH₂)₃—Si(OCH₃)₃, H₂N(CH₂)₂NH(CH₂)₂NH(CH₂)₃—Si(OC₂H₅)₃, cyclo-C₆H₁₁NH(CH₂)₃—Si (OCH₃)₃, cyclo-C₆H₁₁NH(CH₂)₃—Si(OC₂H₅)₃, cyclo-C₆H₁₁NH(CH₂)₃—Si(OCH₃)₂CH₃, cyclo-C₆H₁₁NH(CH₂)₃—Si(OC₂H₅)₂CH₃, cyclo-C₆H₁₁NH(CH₂)₃—Si (OH)₃, cyclo-C₆H₁₁NH(CH₂)₃—Si (OH)₂CH₃, phenyl-NH(CH₂)₃—Si(OCH₃)₃, phenyl-NH (CH₂)₃—Si(OC₂H₅)₃, phenyl-NH(CH₂)₃—Si (OCH₃)₂CH₃, phenyl-NH(CH₂)₃—Si(OC₂H₅)₂CH₃, phenyl-NH(CH₂)₃—Si(OH)₃, phenyl-NH(CH₂)₃—Si(OH)₂CH₃, HN((CH₂)₃—Si(OCH₃)₃)₂, HN((CH₂)₃—Si(OC₂H₅)₃)₂HN((CH₂)₃—Si(OCH₃)₂CH₃)₂, HN((CH₂)₃—Si(OC₂H₅)₂CH₃)₂, cyclo-C₆H₁₁NH(CH₂)—Si(OCH₃)₃, cyclo-C₆H₁₁NH(CH₂)—Si(OC₂H₅)₃, cyclo- C₆H₁₁NH(CH₂)—Si(OCH₃)₂CH₃, cyclo- cyclo-C₆H₁₁NH(CH₂)—Si(OC₂H₅)₂CH₃, cyclo-C₆H₁₁NH(CH₂)—Si(OH)₃cyclo-C₆H₁₁NH(CH₂)—Si(OH)₂CH₃, phenyl-NH(CH₂)—Si(OCH₃)₃, phenyl-NH(CH₂)—Si(OC₂H₅)₃, phenyl-NH(CH₂)—Si(OCH₃)₂CH₃, phenyl-NH(CH₂)—Si(OC₂H₅)₂CH₃, phenyl-NH(CH₂)—Si(OH)₃, and phenyl-NH(CH₂)—Si(OH)₂CH₃, and also their partial hydrolyzates, with preference being given to H₂N (CH₂)₂NH (CH₂)₃—Si(OCH₃)₃, H₂N(CH₂)₂NH (CH₂)₃—Si(OC₂H₅)₃, H₂N (CH₂)₂NH(CH₂)₃—Si(OCH₃)₂CH₃, cyclo-C₆H₁₁NH(CH₂)₃—Si(OCH₃)₃, cyclo-C₆H₁₁NH(CH₂)₃—Si(OC₂H₅)₃, and cyclo-C₆H₁₁NH(CH₂)₃—Si(OCH₃)₂CH₃, and also, in each case, their partial hydrolyzates, and particular preference being given to H₂N(CH₂)₂NH(CH₂)₃—Si(OCH₃)₃, H₂N(CH₂)₂NH(CH₂)₃—Si(OCH₃)₂CH₃, cyclo-C₆H₁₁NH(CH₂)₃—Si(OCH₃)₃, cyclo-C₆H₁₁NH(CH₂)₃—Si(OCH₃)₂CH₃, and also, in each case, their partial hydrolyzates.

The additive may further comprise

(B) at least one polyorganosiloxane comprising structural units of formula (II)

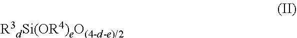

where

R³ may be identical or different and denotes an alkyl, aryl, or alkoxy group,

R⁴ be identical or different and denotes a hydrogen atom, an alkyl, or an aryl group,

d is 0, 1, 2, or 3,

e is 0, 1, 2, or 3,

with the proviso that the sum of d+e is less than or equal to 3.

Preferably, polyorganosiloxane (B) is selected from one or more silicone resins having a number average molecular weight Mn in the range of from about 250 to about 5,000.

The number-average molar weight Mn can be determined by means of Size Exclusion Chromatography (SEC). The measurement can be carried out against polystyrene standard, in THE, at 60° C., a 1.2 ml/min flow rate, and detection by RI (refractive index detector) on a Styragel HR3-HR4-HR5-HR5 column set from Waters Corp. USA, with an injection volume of 100 μl.

The silicone resin consists of M, D, T and Q-units, preferably of M, D and T units, more preferably of D and T-units, even more preferably the ratio between D- and T-units is 5/95 or even higher in T-units, wherein M, D, T, Q-Units are defined as M-unit: R₃SiO_{1/2}; D-Unit: R₂SiO_{2/2}; T-Unit: RSiO_{3/2}; Q-Unit: SiO_{4/2}

wherein each R is independently selected from the group of alkyl, aryl, alkoxy groups having up to eight carbon atoms

Examples of suitable silicone resins include but are not limited to alkoxy- and/or silanol-functional silicone resins known to those skilled in the art. Alkoxy-and/or hydroxyfunctional silicone resins are commercially available from several companies like Bluestar Silicones, DowCorning, Momentive Performance Materials or Wacker Chemie AG. Suitable silicone resins from Wacker Chemie AG include, but are not limited to SILRES® SY-231, IC-232, IC-368, IC-678, IC-836, REN 50/60/80, REN 100, REN 168, SY-409, SY-430, SY-530, KX, HK46, MK, 610, MSE 100, REN 100.

Preferably, the silicone resin is an alkoxyfunctional silicone resin. More preferably, the alkoxyfunctional silicone resin comprises methyl and phenyl groups. Even more preferably, the alkoxyfunctional silicone resin does not comprise epoxy, amino or acid groups.

Preferably, the number average molecular weight Mn of the polysiloxane is higher than about 250, preferably higher than about 500, and lower than about 5,000, more preferably lower than 4,000.

In a preferred embodiment the additive comprises a combination of

(A1) at least one silane of formula (III)

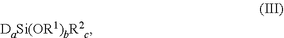

where

D, R1, R2, a, b and c are as defined above, with the proviso that the sum of a+b+c is equal to 4 and there is at least one radical D present per molecule. and

(B1) at least one silicone resin comprising structural units of formula (IV)

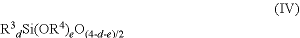

where

R³, R⁴, d and e are as defined above,

with the proviso that the sum of dte is less than or equal to 3 and the number average molecular weight Mn of the silicone resin is in the range of from about 250 to about 5,000.

Preferably, the additive consists of
5 to 100 wt.-%, preferably 10 to 50 wt.-% of component (A), (A1), (A2) or a combination of (A1) and (A2)
0 to 95 wt.-%, preferably 50 to 90 wt.-% of component (B) or (B1)

based on the total weight of the additive.

Preferably, the additive is used in an amount of 0.2 wt.-% to 10 wt.-%, more preferably 0.3 wt.-% to 5 wt.-%, in particular 0.5 wt.-% to 2 wt.-% based on the weight of the carpet fiber board composition (including water).

Preferably, the additive is added during the manufacture of the carpet fiber boards.

The manufacture of carpet fiber boards is generally known in the art as, for example, described in U.S. Pat. No. 9,637,920 B2.

The present invention further relates to a method of producing carpet fiber boards comprises the following steps:

(a) mixing in any order carpet waste, at least one reinforcing filler, at least one binding agent and the additive according to the present invention with water, and

(b) pressing and heating the composition of step (a).

Preferably, the method according to the present invention comprises the following steps:

(a) mixing carpet waste and at least one reinforcing filler,

(b) admixing water and, optionally, colorants, fire retardants, defoamers, lubricants, compatibilizers, coupling agents, and/or mold inhibitors to the composition of step (a),

(c) admixing the additive according to the present invention to the composition of step (b),

(d) admixing a binding agent to the composition of step (c),

(e) pressing and heating the composition of step (d).

Preferably, the additive is added in an amount of 0.2 wt.-% to 10 wt.-%, more preferably 0.3 wt.-% to 5 wt.-%, in particular 0.5 wt.-% to 2 wt.-% based on the weight of the carpet fiber board composition (including water).

Suitable carpet waste is known in the art and preferably comprises wool, nylon, polyester, polyethylene, polypropylene, polyethylene terephthalate, acrylic polymer, polyvinylchloride, latex, jute, sisal, or combinations thereof.

Suitable reinforcing fillers are known in the art and are preferably selected from the group consisting of perlite, volcanic ash, fly ash, talc, calcium carbonate, and combinations thereof.

Suitable binding agents are known in the art and are preferably selected from the group consisting of methylene diphenyl diisocyanate, polymeric methylene diphenyl diisocyanate, urea formaldehyde, melamine urea formaldehyde, melamine resin, phenol formaldehyde, and combinations thereof. Most preferably, the binding agent is methylene diphenyl diisocyanate.

Suitable colorants, fire retardants, defoamers, lubricants, compatibilizers, coupling agents, and mold inhibitors are known in the art.

The carpet board composition preferably consists of:
50 to 75 parts by weight, preferably 60 to 70 parts by weight of carpet waste,
15 to 35 parts by weight, preferably 20 to 30 parts by weight of reinforcing filler,
1 to 10 parts by weight, preferably 2 to 8 parts by weight of binding agent,
2 to 15 parts by weight, preferably 4 to 10 parts by weight of water,
0.2 to 10 parts by weight, preferably 0.3 to 5 parts by weight, more preferably, 0.5 to 2 parts by weight of the additive according to the present invention,
0 to 5 parts by weight of further optional components.

In a particularly preferred embodiment, the carpet board composition preferably consists of:
50 to 75 parts by weight,
15 to 35 parts by weight,
1 to 10 parts by weight, preferably 2 to 8 parts by weight of binding agent,
5 to 10 parts by weight of water,
0.5 to 3 parts by weight of the additive according to the present invention,
0 to 5 parts by weight of further optional components.

Suitable press machines that are capable of maintaining a range of temperatures and pressures are known in the art, such as for example, a continuous roll press.

For example, pressures from 150 psi to 6,000 psi (1,034 kPa to 41,369 kPa), preferably from 300 to 4,000 psi (2,068 kPa to 27,579 kPa), more preferably, from 350 to 2,000 psi (2,413 kPa to 13, 789 kPa), are used to squeeze the fiber board to the desired thickness and density of the final product.

For example, temperatures from 35° C. to 550° ° C., preferably, 100° C. to 400° C., more preferably, from 200° ° C.to 350° C. are used to heat the fiber board. Heating ensures activation of the binding agent and melting of certain fibers (if desired).

### EXAMPLES

### Materials

Carpet waste: Polyethylene Terephthalate Waste Carpet Fiber Reinforcing filler: Perlite/Volcanic Ash

Colorant: UV Romelia Brown Colorant available from ORCO

Binding agent: Lupranate® M20 Isocyanate (polymeric methylene diphenyl diisocyanate, MDI) available from BASF SE

Additive components:
SILRES® MSE 100 (methoxyfunctional methyl polysiloxane) available from Wacker Chemie AG
GENIOSIL® GF 9 (N-(2-Aminoethyl) -3-aminopropyltrimethoxysilane) available from Wacker Chemie AG
SILRES® IC 368 (methoxyfunctional methyl-phenyl polysiloxane) available from Wacker Chemie AG
WACKER® Adhesion Promoter AMS 60 (aminofunctional siloxane) available from Wacker Chemie AG

### Preparation of Fiber Boards

In a mixer 66 parts by weight (pbw) of carpet waste were mixed with 25 pbw of reinforcing filler. 1 pbw of colorant was added and mixed into the composition, followed by 6 pbw of binding agent, 0 to 2 pbw of the additive and 4 to 10 pbw of water while mixing (compositions and order of addition see Tables 1 to 3). The composition was removed from the mixer and placed into a (non-heated) pre-press at 750 psi (5,171 kPa) for 10 seconds. The resulting cake is placed between two steel plates and present to a thickness of 1 inch (2.54 cm) at 750 psi (5,171 kPa) and 450° F. (232° C.) for 10 minutes. After cooling the resulting board was cut to size for testing.

### Method for Determining the Water Absorption

The samples are cured for a prescribed amount of time after they have been produced, typically 4 weeks. The samples are then pre-weighed dry. The samples are then placed in water and weighted down with a stainless steel metal mesh rack. The samples are removed from water weekly (or as specified below), blotted dry, and reweighed, then placed back in the water. After 4 weeks (or 30 days) the samples are weighed a final time. The water absorption % is calculated by the change in weight of the sample from dry to wet.

### Method for Determining the Flexural Strength

The dry samples are measured after 4-weeks of curing/drying.

The wet samples are measured immediately after they are removed from water, blotted dry and weighed for water absorption. DIN/EN 196-1 is used as the test method, including the pre-load, and rate of testing. The following conditions have been used: the samples are the carpet fiber boards, that have been cut into 8 inch (20.32 cm) long sections, that are 1 inch (2.54 cm) by 1 inch (2.54 cm) (width by height). An adjustable three-point flexural testing fixture is used, and is adjusted to measure the flexural strength with a 6 inch (15.24 cm) space between the bottom to points, with the top point pushing down in the exact center, thus with 4 inches (10.16 cm) on either side of the sample, and with 3 inches (7.62 cm) on either side for the bottom two holding points. The results are reported in psi.

The compositions, conditions and test results of the examples are shown in the following tables. In respect of the order of additions the following meanings shall apply: Iso=binding agent; Wat=water; Sil=additive.

TABLE 1

| Example | 1 | 2 | 3 | 4 | 5 | 6 | 16* |
|---|---|---|---|---|---|---|---|
| Order of | Iso:Wat:Sil | Iso:Sil:Wat | Sil:Wat:Iso | Sil:Iso:Wat | Wat:Iso:Sil | Wat:Sil:Iso | Wat:Iso |
| addtion* | | | | | | | |
| Amount | 5 | 5 | 5 | 5 | 5 | 5 | 5 |
| water | | | | | | | |
| (pbw) | | | | | | | |
| Amount of | 2 | 2 | 2 | 2 | 2 | 2 | None |
| additive | | | | | | | |
| (pbw) | | | | | | | |

Composition of additive (wt.-%)

| | | | | | | | |
|---|---|---|---|---|---|---|---|
| SILRES ® | 18 | 18 | 18 | 18 | 18 | 18 | — |
| MSE 100 | | | | | | | |
| WACKER ® | 10 | 10 | 10 | 10 | 10 | 10 | — |
| AMS 60 | | | | | | | |
| SILRES ® | 72 | 72 | 72 | 72 | 72 | 72 | — |
| IC 368 | | | | | | | |
| GENIOSIL ® | 0 | 0 | 0 | 0 | 0 | 0 | — |
| GF 9 | | | | | | | |
| Total | 100 | 100 | 100 | 100 | 100 | 100 | — |

Water Absorption in %

| | | | | | | | |
|---|---|---|---|---|---|---|---|
| Initial | 0.00 | 0.00 | 0.00 | 0.00 | 0.00 | 0.00 | 0.00 |
| 7 Day | 10.96 | 8.37 | 9.30 | 9.31 | 9.43 | 6.48 | 19.36 |
| 14 Day | 13.05 | 10.20 | 9.97 | 10.77 | 11.48 | 7.80 | 19.84 |
| 21 Day | 14.08 | 11.11 | 10.77 | 11.54 | 12.32 | 8.51 | 20.11 |
| 28 Day | 15.55 | 12.54 | 11.96 | 12.50 | 13.70 | 9.47 | 20.69 |

*not according to the invention

TABLE 2

| Example | 7 | 8 | 9 | 10 | 11 | 12* | 13 | 16* |
|---|---|---|---|---|---|---|---|---|
| Order of | Iso:Wat:Sil | Iso:Wat:Sil | Iso:Wat:Sil | Iso:Wat:Sil | Iso:Wat:Sil | Iso:Wat:Sil | Iso:Wat:Sil | Wat:Iso |
| addtion* | | | | | | | | |
| Amount water | 5 | 5 | 5 | 5 | 5 | 5 | 5 | 5 |
| (pbw) | | | | | | | | |
| Amount of | 1 | 0.5 | 2 | 2 | 2 | 2 | 2 | None |
| additive (pbw) | | | | | | | | |

Composition of additive (wt.-%)

| | | | | | | | | |
|---|---|---|---|---|---|---|---|---|
| SILRES ® MSE | 18 | 18 | 18.9 | 16 | 0 | 100 | 60 | — |
| 100 | | | | | | | | |
| WACKER ® AMS 60 | 10 | 10 | 5 | 20 | 100 | 0 | 0 | — |
| SILRES ® IC 368 | 72 | 72 | 76.1 | 64 | 0 | 0 | 0 | — |
| GENIOSIL ® GF 9 | 0 | 0 | 0 | 0 | 0 | 0 | 40 | — |
| Total | 100 | 100 | 100 | 100 | 100 | 100 | 100 | — |

Water Absorption in %

| | | | | | | | | |
|---|---|---|---|---|---|---|---|---|
| Initial | 0.00 | 0.00 | 0.00 | 0.00 | 0.00 | 0.00 | 0.00 | 0.00 |
| 7 Day | 8.57 | 10.94 | 11.14 | 12.25 | 9.52 | 23.39 | 7.86 | 19.36 |
| 14 Day | 10.46 | 12.96 | 13.32 | 14.51 | 12.17 | 23.67 | 11.01 | 19.84 |
| 21 Day | 11.47 | 14.01 | 14.26 | 15.70 | 13.55 | 23.94 | 12.57 | 20.11 |
| 28 Day | 13.24 | 15.79 | 15.68 | 17.52 | 14.97 | 24.29 | 14.35 | 20.69 |

*not according to the invention

TABLE 3

| Example | 14 | 15 | 16* |
|---|---|---|---|
| Order of addtion* | Iso:Wat:Sil | Iso:Wat:Sil | Wat:Iso |
| Amount water (pbw) | 10 | 2.5 | 5 |
| Amount of | 2 | 2 | None |
| additive (pbw) | | | |

Composition of additive (wt.-%)

| | | | |
|---|---|---|---|
| SILRES ® MSE 100 | 18 | 18 | — |
| WACKER ® AMS 60 | 10 | 10 | — |
| SILRES ® IC 368 | 72 | 72 | — |
| GENIOSIL ® GF 9 | 0 | 0 | — |
| Total | 100 | 100 | — |

Water Absorption in %

| | | | |
|---|---|---|---|
| Initial | 0.00 | 0.00 | 0.00 |
| 7 Day | 7.77 | 9.81 | 19.36 |
| 14 Day | 9.10 | 12.95 | 19.84 |
| 21 Day | 9.72 | 14.60 | 20.11 |
| 28 Day | 10.71 | 17.34 | 20.69 |

Flexural Strength in psi (kPa)

| | | | |
|---|---|---|---|
| Dry | 5,980 (41,231) | — | 4,220 (29,096) |
| Wet soaked 28 days | 4,940 (34,060) | — | 3,670 (25,304) |
| Freeze/thaw | 4,860 (33,509) | — | 3,660 (25,235) |
| (14 days wet/ | | | |
| 14 days frozen) | | | |

*not according to the invention

TABLE 4

| Example | 17* | 18 | 19 | 20 | 21 | 22 | 23 |
|---|---|---|---|---|---|---|---|
| Order of | Wat:Iso | Wat:Sil:Iso | Wat:Sil:Iso | Wat:Sil:Iso | Wat:Sil:Iso | Wat:Sil:Iso | Wat:Sil:Iso |
| addtion* | | | | | | | |
| Amount water | 9 | 9 | 6 | 9 | 9 | 9 | 9 |
| (pbw) | | | | | | | |
| Amount of | None | 0.7 | 1 | 1 | 1.3 | 1 | 1 |
| additive (pbw) | | | | | | | |

Composition of additive (wt.-%)

| | | | | | | | |
|---|---|---|---|---|---|---|---|
| SILRES ® MSE 100 | — | 60 | 60 | 60 | 60 | 75 | 90 |
| GENIOSIL ® GF 9 | — | 40 | 40 | 40 | 40 | 25 | 10 |
| Total | — | 100 | 100 | 100 | 100 | 100 | 100 |

Water Absorption

| | | | | | | | |
|---|---|---|---|---|---|---|---|
| Initial | 0.00 | 0.00 | 0.00 | 0.00 | 0.00 | 0.00 | 0.00 |
| 30 Days | 10.84 | 6.78 | 5.98 | 6.69 | 7.71 | 7.58 | 8.72 |

*not according to the invention

1-10. (canceled)

11. Use of an additive for decreasing the water absorption and improving the flexural strength of carpet fiber boards, wherein the additive comprises:
(A) at least one organosilicon compound comprising structural units of formula (I) 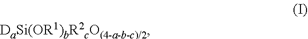
wherein D may be identical or different and denotes a monovalent, SiC-bonded radical containing basic nitrogen;
wherein R¹ may be identical or different and denotes a hydrogen atom or optionally substituted hydrocarbon radicals;
wherein R² may be identical or different and denotes a monovalent, optionally substituted, SiC-bonded organic radical free from basic nitrogen;
wherein a is 0, 1, 2, 3, or 4;
wherein b is 0, 1, 2, or 3;
wherein c is 0, 1, 2, or 3;
wherein the sum of a+b+c is less than or equal to 4 and there is at least one radical D present per molecule; and
wherein the additive is added during the manufacture of the carpet fiber boards.

12. The use of claim 11, wherein the organosilicon compound is,
(A1) a silane, wherein a+b+c is equal to 4; or
(A2) a (poly)organosiloxane, wherein a+b+c is less than or equal to 3,
or a combination of (A1) and (A2).

13. The use of claim 11, wherein the organosilicon compound is,
(A1) a silane, wherein a+b+c is equal to 4.

14. The use of claims 11, wherein the additive further comprises:
(B) at least one polyorganosiloxane comprising structural units of formula (II) 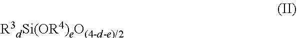
wherein R³ may be identical or different and denotes an alkyl, aryl, or alkoxy group;
wherein R⁴ be identical or different and denotes a hydrogen atom, an alkyl, or an aryl group;
wherein d is 0, 1, 2, or 3;
wherein e is 0, 1, 2, or 3; and
wherein the sum of d+e is less than or equal to 3.

15. The use of claim 14, wherein the at least one polyorganosiloxane (B) is selected from one or more silicone resins having a number average molecular weight Mn in the range of from about 250 to about 5,000.

16. The use of claim 11, wherein the additive comprises a combination of
(A1) at least one silane of formula (III) 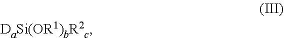
wherein D may be identical or different and denotes a monovalent, SiC-bonded radical containing basic nitrogen;
wherein R¹ may be identical or different and denotes a hydrogen atom or optionally substituted hydrocarbon radicals;
wherein R² may be identical or different and denotes a monovalent, optionally substituted, SiC-bonded organic radical free from basic nitrogen;
wherein a is 0, 1, 2, 3, or 4;
wherein b is 0, 1, 2, or 3;
wherein c is 0, 1, 2, or 3; and
wherein the sum of a+b+c is equal to 4 and there is at least one radical D present per molecule; and
(B1) at least one silicone resin comprising structural units of formula (IV) 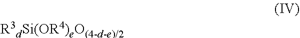
wherein R³ may be identical or different and denotes an alkyl, aryl, or alkoxy group;
wherein R4 be identical or different and denotes a hydrogen atom, an alkyl, or an aryl group;
wherein d is 0, 1, 2, or 3;
wherein e is 0, 1, 2, or 3;
wherein the sum of d+e is less than or equal to 3; and
wherein the number average molecular weight Mn of the silicone resin is in the range of from about 250 to about 5,000.

17. The use of claim 11, wherein the additive is used in an amount of 0.2 wt.-% to 10 wt.-% based on the total weight of the carpet fiber board composition.

18. A method of producing carpet fiber boards, comprising the following steps:
(a) providing an additive, wherein the additive comprises (A) at least one organosilicon compound comprising structural units of formula (I) 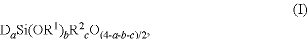
wherein D may be identical or different and denotes a monovalent, SiC-bonded radical containing basic nitrogen;
wherein R¹ may be identical or different and denotes a hydrogen atom or optionally substituted hydrocarbon radicals;
wherein R² may be identical or different and denotes a monovalent, optionally substituted, SiC-bonded organic radical free from basic nitrogen;
wherein a is 0, 1, 2, 3, or 4;
wherein b is 0, 1, 2, or 3;
wherein c is 0, 1, 2, or 3;
wherein the sum of a+b+c is less than or equal to 4 and there is at least one radical D present per molecule; and
wherein the additive is added during the manufacture of the carpet fiber boards;
(b) mixing in any order carpet waste, at least one reinforcing filler, at least one binding agent and the additive with an amount of water; and
(c) pressing and heating the composition of step (a).

19. The method of claim 18, wherein the method comprises the following steps:
(a) mixing carpet waste and at least one reinforcing filler;
(b) admixing water and, optionally, colorants, fire retardants, defoamers, lubricants; compatibilizers, coupling agents, and/or mold inhibitors to the composition of step (a);
(c) admixing the additive to the composition of step (b);
(d) admixing a binding agent to the composition of step (c); and
(e) pressing and heating the composition of step (d).

20. The method of claim 18, wherein the additive is added in an amount of 0.2 wt.-% to 10 wt.-% based on the total weight of the carpet fiber board composition.
